(19) United States
(12) Patent Application Publication
(10) Pub. No.: US 2008/0018677 A1
(43) Pub. Date: Jan. 24, 2008

(54) METHODS AND APPARATUS FOR INKJET PRINT HEAD CLEANING USING AN INFLATABLE BLADDER

(76) Inventors: John M. White, Hayward, CA (US); Shinichi Kurita, San Jose, CA (US)

Correspondence Address: DUGAN & DUGAN, PC, 245 Saw Mill River Road, Suite 309, Hawthorne, NY, 10532, US

(21) Appl. No.: 11/762,008

(22) Filed: Jun. 12, 2007

Related U.S. Application Data
(63) Continuation-in-part of application No. 11/238,631, filed on Sep. 29, 2005.

(51) Int. Cl. B41J 29/38; B41J 2/165

(52) U.S. Cl. 347/5; 347/33; 347/35

(57) ABSTRACT

Methods and apparatus for cleaning a nozzle plate of an inkjet print head are provided. A first method includes positioning a cleaning medium proximate the inkjet print head, determining a pressure for an inflatable bladder to apply against the cleaning medium, contacting the cleaning medium with the bladder with the determined pressure, and moving the cleaning medium relative to the inkjet print head so as to clean the inkjet print head. The method also includes purging ink from the inkjet print head prior to the bladder contacting the cleaning medium and pre-jetting ink from the inkjet print head after moving the cleaning medium. Numerous other aspects are provided.

The present application claims priority from and is a continuation-in-part of U.S. patent application Ser. No. 11/238,631, filed Sep. 29, 2005 (Attorney Docket No. 9838) and entitled “Methods And Apparatus For Inkjet Print Head Cleaning”, which is hereby incorporated by reference herein in its entirety for all purposes.

### FIELD OF THE INVENTION

The present invention relates generally to inkjet printing systems employed during flat panel display formation, and is more particularly concerned with apparatus and methods for cleaning inkjet print heads.

### BACKGROUND OF THE INVENTION

The flat panel display industry has been attempting to employ inkjet printing to manufacture display devices, in particular, color filters. However, inkjet print heads used in inkjet printing may become filled with ink, clogged, coated, or otherwise rendered unsuitable for use in an inkjet printing process. Conventional methods for cleaning inkjet print heads involve a manual wiping process. This process often includes bringing inkjet print heads offline and away from a clean production environment, is slow and may damage or shift a print head from a desired print position. Accordingly, improved methods and apparatus for cleaning an inkjet print head are desired.

### SUMMARY OF THE INVENTION

In certain aspects of the invention, a method for cleaning a nozzle plate of an inkjet print head is provided. The method includes positioning a cleaning medium proximate the inkjet print head, determining a pressure for an inflatable bladder to apply against the cleaning medium, contacting the cleaning medium with an inflatable bladder; and with the determined pressure, exerting a force on the cleaning medium relative to the inkjet print head so as to clean the inkjet print head.

In other aspects of the invention, an apparatus for inkjet print head cleaning is provided. The apparatus includes a cleaning station adapted to provide a location to support an inkjet print head during cleaning, an inflatable bladder adapted to adjustably move a cleaning medium proximate to the cleaning station, and a pressure regulator adapted to set a pressure and volume of the inflatable bladder to adjust a pressure of the bladder against the cleaning medium during cleaning of the inkjet print head at the cleaning station.

### BRIEF DESCRIPTION OF THE DRAWINGS

FIG. 1 is a side view of an inkjet print head cleaning system according to some embodiments of the present invention.

FIG. 2 is an enlarged side view of the inkjet print head cleaning apparatus of FIG. 1 according to some embodiments of the present invention.

FIG. 3 is a flowchart illustrating an exemplary method of inkjet print head cleaning according to some embodiments of the present invention.

FIG. 4 is a side view of an inkjet print head cleaning system according to alternative embodiments of the present invention.

FIG. 5 is an enlarged side view of the inkjet print head cleaning apparatus of FIG. 4 according to alternative embodiments of the present invention.

FIG. 6 is a flowchart illustrating an exemplary method of inkjet print head cleaning according to alternative embodiments of the present invention.

### DETAILED DESCRIPTION

The present invention provides methods and apparatus for inkjet print head cleaning. According to some embodiments of the present invention, a pressure roller may cause a movable cleaning medium to contact or nearly contact the nozzle plate of an inkjet print head, thus wiping the nozzle plate clean. For example, the moving cleaning medium may be positioned close to and/or brought into contact with the nozzle plate so as to remove liquid ink adhered to the nozzle plate without contacting the nozzle plate (e.g., wick, wipe or scrape, depending on the pressure applied).

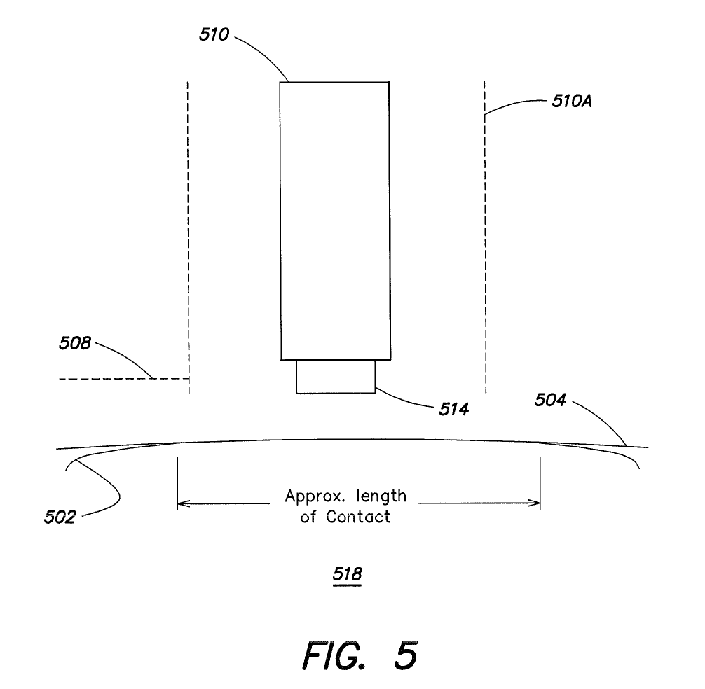

In alternative embodiments of the present invention, an inflatable bladder is used instead of a pressure roller to cause a movable cleaning medium to contact or nearly contact the nozzle plate of an inkjet print head, thus wiping the nozzle plate clean. The inflatable bladder may be controllably inflated to support the cleaning medium in position whereby its cleaning potential is maximized. In one or more embodiments, the inflatable bladder may provide a large contacting surface (shown in greater detail in FIG. 5) for supporting and applying force to the cleaning medium, which in turn may provide a uniform contact and/or maintain a substantially parallel planar relationship between the cleaning medium and the nozzle plate of a print head.

In some embodiments, one or more adjustment rollers may be utilized to adjust an approach angle and/or departure angle of the cleaning medium with respect to the nozzle plate. For example, the approach angle and departure angle may be optimized to bring the cleaning medium into a substantially parallel planar relationship with the nozzle plate while preventing the cleaning medium from abrading a leading edge of the nozzle plate. In the same or other embodiments, the cleaning medium may be spooled between a feed roller and a take up roller and/or may be tensioned via a tension roller. In addition, the tension roller, adjustment roller, and pressure roller may be independently adjustable such that the cleaning medium may be positioned for optimal wiping. In such embodiments, the tension roller, adjustment roller, and pressure roller may be monitored and adjusted either manually or automatically (e.g., by a control mechanism or mechanisms).

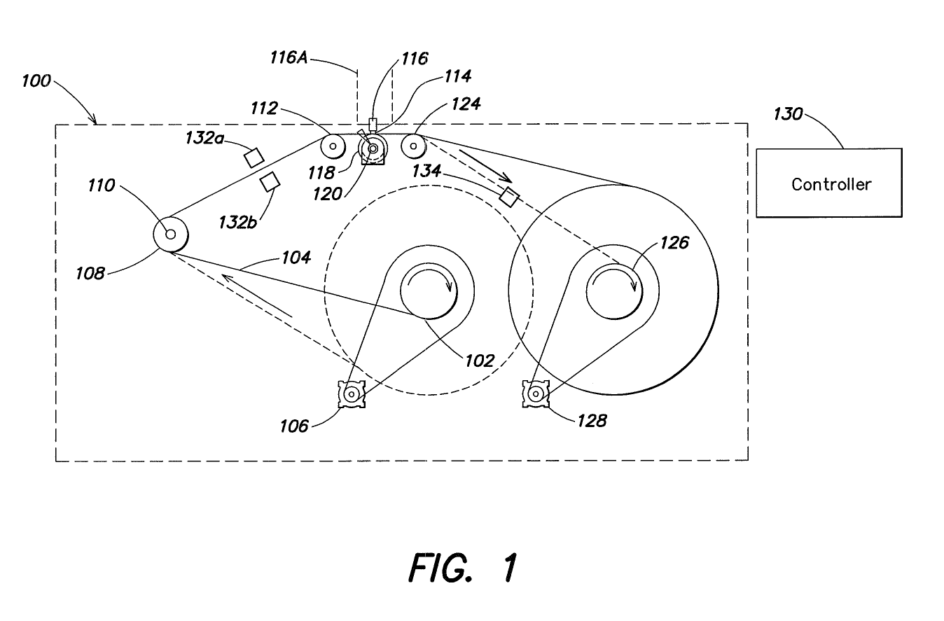

FIG. 1 illustrates a side view of a first embodiment of an inkjet print head cleaning system of the present invention which is designated generally by the reference numeral 100. The inkjet print head cleaning system 100, in an exemplary embodiment, may include a feed roller 102 which initially carries a spool of a cleaning medium 104 and which may be driven by feed motor 106. Cleaning medium 104 may be passed over and tensioned by a tension roller 108, which may include a tension roller sensor 110. Cleaning media 104 may then be passed over an adjustment roller 112, which may adjust an approach angle of the cleaning medium 104 with respect to a nozzle plate 114 of a print head 116. The print head 116 may be located at a cleaning station or other parking location 116A during cleaning.

In one or more embodiments, the cleaning medium 104 may be moved proximate to the nozzle plate 114 by a pressure roller 118. Pressure roller 118 may include shaft encoder 120 to measure the rotational velocity of the pressure roller 118, which may be converted to a speed of the cleaning medium 104. The other rollers of the cleaning system 100 may be similarly configured. Cleaning medium 104 may then be passed over an idle roller 124 before being spooled on a take up roller 126, which may be driven by a take up motor 128. The cleaning system 100 may also include a controller 130 coupled to any of feed roller 102, feed motor 106, tension roller 108, tension roll sensor 110, adjustment roller 112, pressure roller 118, shaft encoder 120, idle roller 124, take up roller 126, take up motor 128, or any other part of cleaning system 100.

A cleaning medium breakage sensor 132 may be employed in the system 100 adjacent cleaning medium 104 to determine whether the cleaning medium 104 is damaged and/or broken during cleaning; and a feed roller empty sensor 134 may be disposed adjacent feed roller 102 to determine whether the feed roller 102 is empty or about to be empty. The cleaning medium sensor 132 and/or feed roller empty sensor 134 also may be coupled to the controller 130.

In the exemplary embodiment of FIG. 1, the feed roller 102 may initially hold a spool or roll of cleaning medium 104. In some embodiments, the feed roller 102 may be formed from Teflon® and/or aluminum and have a diameter of about 3 to 4 inches, although other materials and/or sizes may be used. Cleaning medium 104 may be threaded from the feed roller 102 over the tension roller 108, adjustment roller 112, pressure roller 118, and idle roller 124 to be wrapped onto take up roller 126. In some embodiments, fewer or more rollers may be employed. For example, in at least one embodiment, the tension roller 108 and idle roller 124 may be eliminated.

The cleaning medium 104 may be any material suitable for use in wiping the nozzle plate 114 or other surface of a print head 116, such as a particle free medium, and may contain a cleaning fluid (e.g., water or solvent) suitable for cleaning inkjet print heads. For example, the cleaning medium 104 may be 100% non-woven polyester, such as SatWipes C3 Wiper manufactured by Contec, Inc. of Spartanburg, S.C. In some embodiments a solvent (e.g., PGMEA (propylene glycol methyl ether acetate), acetone, etc.) or other cleaning fluid may be sprayed (e.g., via a spray nozzle) or otherwise deposited onto the cleaning medium 104. In the same or other embodiments, the cleaning fluid may be deposited directly onto the inkjet print head 116.

In some embodiments, the tension roller 108 may be formed from Teflon® and/or aluminum and have a diameter of about one inch, although other materials and/or sizes may be used. The tension of the cleaning medium 104 may be measured via the tension sensor 110. This information may be relayed to controller 130. The relative position and angle of tension roller 108 may be adjusted based on the determined tension (e.g., manually or automatically, such as under direction of the controller 130) to achieve a desired tension of the cleaning medium 104. In at least one embodiment, tension of the cleaning medium 104 may be approximately 50 to 1000 grams, although any appropriate tension may be used. In the same or alternative embodiments, tension may be determined in part by measuring motor torque of feed motor 106 and/or take-up motor 128.

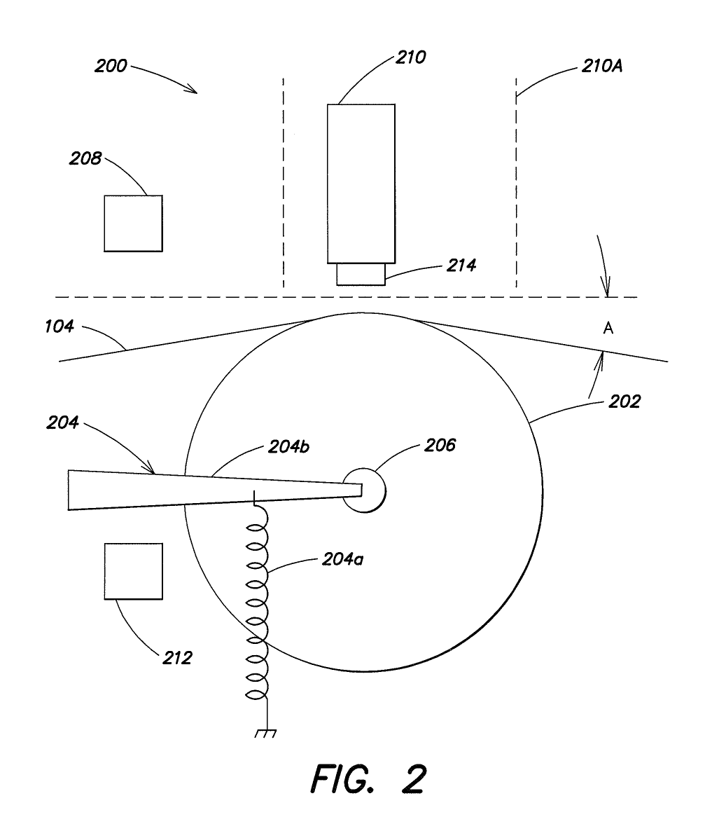

The adjustment roller 112 may be adjustable so as to change the angle of approach A, illustrated in FIG. 2, of the cleaning medium 104 with respect to the nozzle plate 114. It may be desirable to achieve as small an approach angle as possible, preferably about 15 degrees or less, so as to maintain a substantially parallel planar relationship between the nozzle plate 114 and the cleaning medium 104 at the point of contact. The approach angle may be adjusted such that the maximum wiping occurs without shaving the nozzle plate 114 or causing misalignment of print head 116. Shaving may result from the cleaning medium 104 contacting a leading edge of the nozzle plate 114 causing particle generation.

In at least one embodiment, the adjustment roller 112 may be formed from Teflon® and/or aluminum and have a diameter of about one inch. Other adjustment roller materials and/or sizes may be used.

In some embodiments, the position of the adjustment roller 112 may be adjustable (e.g., by adjustment of a supporting block (not shown)) to compensate for tension variations resulting from changes in the geometry of the cleaning medium 104 path over the tension roller 108 as the roll of cleaning medium 104 is transferred from the feed roller 102 to the take up roller 126. In the same or alternative embodiments, the position of the adjustment roller 112 may also be adjustable to compensate for variations in the thickness of cleaning medium 104 or any offset in the position of inkjet print head 116. Additionally, the position of the adjustment roller 112 may be adjustable to improve clearance so that inkjet print head 116 may be moved to a parking station (not shown) when the print head is not in use. In an exemplary embodiment, with the adjustment roller 112 set to about a two degree approach angle and the pressure roller 118 retracted away from the cleaning station 116A, a clearance of approximately 2.3 mm, less cleaning medium 104 thickness, may be provided for the inkjet print head 116 to pass en route to the parking station (not shown).

During the cleaning operation, inkjet print head 116 may be located at the cleaning station 116A. The cleaning station 116A may be capable of housing a single inkjet print head 116, a row of inkjet print heads 116, an array of inkjet print heads 116, or any other suitable amount and/or arrangement of inkjet print heads 116. In an exemplary embodiment, cleaning station 116A may be a structure adapted to hold an inkjet print head or heads 116 in a particular location. Inkjet print heads 116 may be mounted to a rail (not shown) and may be moved into position at the cleaning station 116A. In other embodiments, the cleaning station 116A may be a space (e.g., gap, door, window, etc.) in a wall surrounding part or all of inkjet print head cleaning system 100.

The pressure roller 118 may be biased toward the nozzle plate 114 using a spring loaded assembly or similar biasing mechanism (as described further below with reference to biasing mechanism 204 in FIG. 2). The pressure roller 118 may be movable via the biasing mechanism to move the cleaning medium 104 proximate to the nozzle plate 114 of the inkjet print head 116 located at cleaning station 116A. In the same or alternative embodiments, the pressure roller 118 may be adjustable about a central axis to maintain a substantially parallel planar relationship between the nozzle plate 114 and the cleaning medium 104. In a preferred embodiment, pressure roller 118 may be formed from a material with some softness, such as Teflon® and/or aluminum and have a diameter of approximately 3 inches. In other embodiments, the pressure roller 118 may have a diameter of between about 16 and 20 mm. Larger or smaller pressure roller diameters may be used, as may other pressure roller materials.

Idle roller 124 may be used to guide cleaning medium 104 and adjust the departure angle of the cleaning medium 104 with respect to the nozzle plate 114 (in a manner similar to how adjustment roller 112 adjusts approach angle). Idle roller 124 may also be used to adjust a tension in cleaning medium 104, and may be of a similar size and material as the adjustment roller 112 (although other sizes and/or materials may be used). The idle roller 124 may be stationary and adjustable in position.

As stated, cleaning medium 104 may be wrapped onto take up roller 126 after use in the inkjet print head cleaning system 100. Take up roller 126 may be driven by take up motor 128. Take up motor 128 may be a belt driven motor, although any other suitable motor may be used. Take up roller 126 may be of a similar size and material as feed roller 102, although other sizes and/or materials may be used.

The controller 130 may be operably connected to the feed motor 106, take up motor 128, tension sensor 110, or any other part of the cleaning system 100. Controller 130 may be any suitable computer or computer system, including, but not limited to, a mainframe computer, a minicomputer, a network computer, a personal computer, and/or any suitable processing device, component, or system. Likewise, the controller 130 may comprise a dedicated hardware circuit or any suitable contribution of hardware and software.

In at least one embodiment, the controller 130 may monitor feed roll size, torque, and/or rotational speed, take up roll size, torque, and/or rotational speed, cleaning medium tension, cleaning medium distance traveled, and/or cleaning media speed. Controller 130 may utilize this information to control the various attributes and components of the system 100 so as to ensure a functional cleaning process. For example, in an exemplary embodiment, controller 130 may monitor tension, speed, and the distance traveled of the cleaning medium 104 as well as the size of the cleaning medium rolled onto feed roll 102 and take up roll 126. As tension is measured by tension sensor 110, this information may be used by the controller 130 to adjust the speed of the feed motor 106 or take up motor 128 (e.g., to keep an approximately constant tension on cleaning medium 104). As the speed of the cleaning medium 104 is monitored, the speeds of both the take up motor 106 and feed motor 128 may be adjusted (e.g. to keep the cleaning medium 104 traveling at an approximately constant speed). Similarly, information about the cleaning medium 104 distance traveled and the size of the cleaning medium 104 rolls on feed roll 102 and take up roll 126 may be used to determine and/or adjust the take up motor 106 speed and feed motor 128 speed (e.g., to affect cleaning medium speed and/or tension). In another embodiment, the speed and distance traveled of the cleaning medium 104, the feed motor 106 torque, and the size of the cleaning medium 104 rolls on feed roll 102 and take up roll 126 may be known, measured, and/or adjustable by controller 130. Cleaning medium 104 speed may be used by the controller 130 to adjust take up motor 128 speed. Feed motor 106 torque may be used by the controller 130 to adjust feed motor 106 torque. Similarly, the diameter of the cleaning medium 104 on either or both of the feed roller 102 and the take-up roller 126 may be used in conjunction with a measured motor torque on either or both of the feed motor 106 and the take-up motor 128 by the controller 130 to control the cleaning medium 104 tension. The motor torque of the feed motor 106 and/or the take-up motor 128 may be inversely proportional to the measured cleaning medium 104 diameter when cleaning medium 104 tension is kept constant.

Cleaning medium breakage sensor 132 is adapted to determine a defect in the cleaning medium 104. In a particular embodiment, breakage sensor 132 may be disposed between the tension roller 108 and adjustment roller 118 although other locations may be used. In some embodiments, breakage sensor 132 may be an optical sensor that detects the presence or absence of the cleaning medium 104 (e.g., via reflection or a through beam) or may be any other suitable sensor or device. For example, the breakage sensor 132 may include a light beam source 132a and a detector 132b that only detects a light beam from the light beam source 132a when the clean medium 104 is not present or improperly positioned between the light beam source 132a and detector 132b. Absence of the cleaning medium 104, or a change in the transmission characteristics through the cleaning medium 104, may indicate a defect (e.g., breakage of the cleaning medium 104, improper cleaning medium type, etc.) Feed roller empty sensor 134 may be disposed adjacent feed roller 102 and be adapted to monitor the roll size of cleaning medium 104 on the feed roller 102. For example, the feed roller empty sensor 134 may include a light source adapted to transmit a light beam toward a detector (not shown) that detects the light beam only if the diameter of cleaning medium 104 on the feed roller 102 is below a predetermined size (e.g., indicating the feed roller 102 is or is about to be empty). Other feed roller empty sensors may be used including, for example, a sensor that measures the weight of the feed roller 102 to determine the amount of cleaning medium 104 on the feed roller 102 or a reflected ultrasound or laser sensor. As cleaning medium 104 pays out during a cleaning process, the roll size (diameter) may be monitored to prevent running out of cleaning medium 104 during the cleaning process. In one embodiment, a feed roller empty sensor 134 may be mounted perpendicular to the feed roller 102.

If a designated cleaning medium 104 roll-change point is desired, a discrete-output sensor may be used, such as the light source/detector embodiment described above. In another embodiment, the feed roller empty sensor 134 may be adapted to measure how much cleaning medium 104 has been payed out by the feed roller 102 and configured and/or programmed with a specific distance which corresponds to a low supply condition, at which point the output of the feed roller empty sensor 134 changes state. If a continuous inventory is desired, an analog-output sensor may be used. Feed roller empty sensor 104 may be taught a distance which corresponds to the full roll, and a distance to the empty roll. As the cleaning medium 104 pays out, the sensor may send an analog signal that is scaled to represent the shrinking size of the roll. Any other suitable sensor may be used.

Feed roller empty sensor 134 may also be used to measure a diameter of the cleaning medium 104 mounted on feed roller 102. The diameter of the cleaning medium 104 may be used by the controller 130 to control tension of the cleaning medium 104.

FIG. 2 depicts a side view of an exemplary embodiment of the pressure roller 118 of FIG. 1 according to the present invention. In the embodiment of FIG. 2, the pressure roller 202 may be supported by a biasing mechanism 204 coupled to a shaft encoder 206. An up limit 208, such as a hard stop, may be provided to prevent pressure roller 202 from causing damage to an inkjet print head 210 located at a cleaning station location 210A. A down limit 212, disposed so as to provide a lower limit of motion for the pressure roller 202, may also be included.

Pressure roller 202 may house shaft encoder 206. In alternative embodiments, shaft encoder 206 may be operably connected to pressure roller 202, but may reside outside of the roller housing. Controller 130 (shown in FIG. 1) may be coupled to shaft encoder 206.

In operation, pressure roller 202 may be operable to apply pressure against the cleaning medium 104 and move the cleaning medium 104 in proximity of cleaning station location 210A, which may house the inkjet print head 210.

An example of a commercially available print head suitable for use with the present invention is the model SX-128, 128-Channel Jetting Assembly manufactured by Spectra, Inc. of Lebanon, N.H. This particular jetting assembly includes two electrically independent piezoelectric slices, each with sixty-four addressable channels, which are combined to provide a total of 128 jets. The print head includes a number of nozzles which are arranged in a single line, at approximately 0.020″ distance between nozzles. Other print heads with differently sized nozzles may also be used.

The biasing mechanism 204 may be any mechanism or structure capable of moving the pressure roller 202 (e.g., spring arm, spring bias, or the like). Biasing mechanism 204 may be operable to move pressure roller 202 in proximity of the nozzle plate 214 of inkjet print head 210, which is located at the cleaning station 210A. The pressure roller 202 may be sized or shaped so as to prevent contact between the pressure roller 202 and corners of the inkjet print head 210. In some embodiments, the pressure exerted against the cleaning medium 104 by the pressure roller 202 or the “pressure roller load” (or the load on biasing mechanism 204) may be set by extension of a spring 204a against an arm 204b. In an alternative embodiment, the load on biasing mechanism 204 may be set by a compression spring (not shown). Any other suitable method for adjusting load on biasing mechanism 204 may be used. Some of the load may offset the weight of pressure roller 202 and biasing mechanism 204. The roller load may be set by extension of the spring. In an alternative embodiment, roller load may be set by compression of the spring. The pressure roller load results in the pressure roller 202 contacting the cleaning medium 104 and applying a desired pressure on the nozzle plate 214. In a preferred embodiment, a spring rate of approximately 9 g/mm may be used to allow an accurate load setting, although any appropriate and/or practible spring rate may be used. The pressure roller load may be set by adjustment of the spring to compensate for changes in cleaning medium 104 tension and approach angle. In the same or alternative embodiments, the pressure roller load may be set to compensate for variations in cleaning medium 104 thickness.

As stated, pressure roller 202 may be limited in movement by up limit 208. Up limit 208 may be any suitable limiting device which will prevent pressure roller 202 from unwanted or excessive contact with inkjet print head 210. In a preferred embodiment, up limit 208 may be set approximately 0.1 mm past the point where pressure roller 202 would contact nozzle plate 214. The up limit 208 may be used to set an initial position for pressure roller 202 and setting of the roller load. Up limit 208 may be set at any appropriate point conducive to the pressure roller 202 diameter, inkjet print head 210 position, or any other factor which may affect the pressure roller 202 contact point.

Pressure roller 202 may be further limited in movement by down limit 212. Down limit 212 may be any suitable limiting device which will prevent pressure roller 202 from contacting other parts of system 100. Down limit 212 may a hard stop, spring return type, or any other suitable limiter.

Pressure roller 202 may house shaft encoder 206. Shaft encoder 206 may be operable to determine a rotational velocity of the pressure roller 202 and convert the rotational velocity to a cleaning medium 104 velocity. Alternatively, shaft encoder 206 may determine a rotational velocity of the pressure roller 202 and relay this information to controller 130. In alternative embodiments, shaft encoder 206 may be operably connected to pressure roller 202, but may reside outside of the roller housing.

Controller 130 (shown in FIG. 1) may be operably connected to pressure roller 202 and/or shaft encoder 206. Controller 130 may be capable of converting information relayed from shaft encoder 206 to information and/or command controls for pressure roller 202 or other elements of system 100. Specifically, controller 130 may be capable of determining a cleaning medium 104 speed based on information relayed by the pressure roller and/or shaft encoder 206.

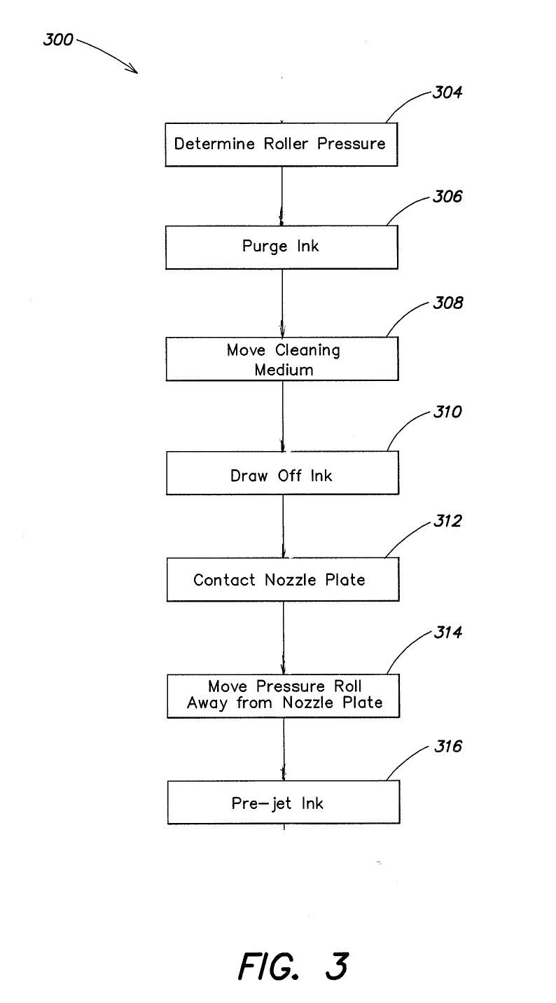

Turning to FIG. 3, a flowchart depicting an exemplary method 300 of inkjet print head cleaning according to the present invention is illustrated. In Step 304, an appropriate pressure to be applied by the pressure roller 202 against the cleaning medium 104 is determined. In at least one embodiment, the pressure should be sufficient so as to cause the web cleaning medium 104 to contact and wipe the nozzle plate 214 of the inkjet print head 210 without causing damage to or misalignment of the inkjet print head 210. The pressure applied by the pressure roller 202 also preferably should not cause shaving (e.g., the web cleaning media 104 preferably does not contact the leading edge of the nozzle plate 214 and/or result in particle generation). The pressure applied by the pressure roller 202 may be determined experimentally or may be set at any pre-determined setting. In some embodiments, the pressure applied may be between about 50 and 200 grams. Other pressures may be used.

In step 306, ink remaining in the inkjet print head 210 may be purged. To purge ink from the print head 210, the inkjet print head may force any remaining ink inside the inkjet print head 210 out of the inkjet print head via any suitable method. This may include, for example, jetting ink or air through the inkjet print head 210. In one or more embodiments, ink or air may be jetted through the inkjet print head 210 using a pulse of duration of about 0.5 seconds, although any other pulse widths may be used. In an exemplary embodiment, inkjet print head 210 may purge between approximately three and six cubic centimeters of ink per cycle. Inkjet print head 210 may be purged onto cleaning medium 104 at cleaning station 210A or at a parking station (not shown).

In step 308, cleaning medium 104 may be moved. Moving cleaning medium 104 may include rotating feed roller 102 so as to dispense cleaning medium 104 from the feed roller 102 and rotating take up roller 126 so as to re-spool used cleaning medium 104 onto the take up roller 126. Any appropriate cleaning medium 104 speed may be employed. In an exemplary embodiment, cleaning medium 104 may be moved at a speed of approximately 10-150 mm/s.

During step 308, the speed of the cleaning medium 104 also may be adjusted. For example, adjustment of a cleaning medium 104 speed may be made by first determining a current cleaning medium speed. The current cleaning medium speed may be determined by measuring a tension of the cleaning medium, a distance traveled by the cleaning medium, comparing a first feed roll size to a second feed roll size, comparing a first take up roll size to a second take up roll size, any combination thereof, or the like. Any other suitable method may be used to determine speed of the cleaning medium 104. The current cleaning medium speed may then be adjusted, for example, by adjusting a feed roller rotational speed, a take up roller rotational speed, a cleaning medium tension, or any combination thereof. Any other suitable method may be used to adjust cleaning medium 104 speed. A feed roller 102 rotational speed may be adjusted by adjusting the motor speed of feed motor 106. Similarly, a take up roller 126 rotational speed may be adjusted by adjusting the motor speed of take up motor 128.

In step 310, pressure roller 202 may be moved against cleaning medium 104 proximate to nozzle plate 214. This may cause any liquid ink remaining on nozzle plate 214 to be wicked or drawn off the nozzle plate 214 onto cleaning medium 104. For example, pressure roller 202 may be moved via biasing mechanism 204 or any suitable method and/or device. The pressure roller 202 may be moved incrementally (e.g., so as to continually adjust pressure roller 202 position, such as based on feedback from controller 130); or pressure roller 202 may be moved in a single step to a predetermined position.

In step 312, pressure roller 202 may be moved against cleaning medium 104 so as to cause cleaning medium 104 to contact the surface of nozzle plate 214 and wipe away any remaining ink. In at least one embodiment, pressure exerted by cleaning medium 104 may be sufficient to scrape away any ink from the nozzle plate 214, but insufficient to cause damage to and/or misalignment of the inkjet print head 210. The biasing mechanism 204 or any other device may be employed to move the pressure roller 202 (e.g., manually or under control of the controller 130).

In step 314, pressure roller 202 may be moved away from inkjet print head 210, causing cleaning medium 104 to be moved away from nozzle plate 214. For example, pressure roller 202 may be moved away via biasing mechanism 204 or any suitable method and/or device. The pressure roller 202 may be moved incrementally away from inkjet print head 210 (e.g., by continually adjusting pressure roller 202 position, such as based on feedback from controller 130); or, the pressure roller 202 may be moved away from inkjet print head 210 in a single step to a predetermined position.

In step 316, ink may be pre-jetted from inkjet print head 210. Pre-jetting ink may cause ink to be jetted from the inkjet print head 210 after cleaning and before returning to a print process. Ink may be pre-jetted onto cleaning medium 104 at cleaning station 210A or may be pre-jetted at a parking station (not shown).

Cleaning System Employing an Inflatable Bladder to Support Cleaning Medium

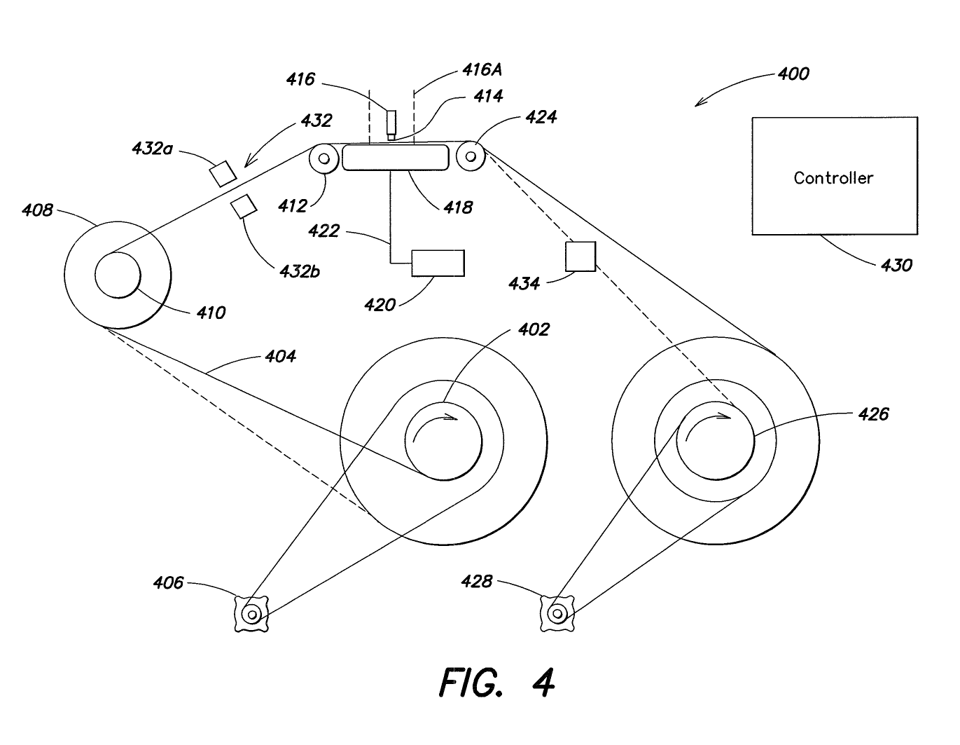

FIG. 4 illustrates a side view of an alternative embodiment of an inkjet print head cleaning system of the present invention which is designated generally by the reference numeral 400. The inkjet print head cleaning system 400, in an exemplary embodiment, may include a feed roller 402 which initially carries a spool of a cleaning medium 404 and which may be driven by feed motor 406. Cleaning medium 404 may be passed over and tensioned by a tension roller 408, which may include a tension roller sensor 410. Cleaning media 404 may then be passed over an adjustment roller 412, which may adjust an approach angle of the cleaning medium 404 with respect to a nozzle plate 414 of a print head 416. The print head 416 may be located at a cleaning station or other parking location 416A during cleaning. One or more of the feed roller 402, the tension roller 408 and/or the adjustment roller 412 may include shaft encoders (not shown) to measure rotational velocity, which may be converted to a speed of the cleaning medium 404.

In one or more embodiments, the cleaning medium 404 may be moved proximate to the nozzle plate 414 by an inflatable bladder 418. A bladder pressure regulator 420 may be used to inflate/deflate the inflatable bladder 418 via a gas conduit 422 to a desired pressure and volume. Cleaning medium 404 may be passed over an idle roller 424 before being spooled on a take up roller 426, which may be driven by a take up motor 428. The cleaning system 400 may also include a controller 430 coupled to any of feed roller 402, feed motor 406, tension roller 408, tension roll sensor 410, adjustment roller 412, inflatable bladder 418, bladder pressure regulator 420, idle roller 424, take up roller 426, take up motor 428, or any other part of cleaning system 400.

A cleaning medium breakage sensor 432 may be employed in the system 400 adjacent cleaning medium 404 to determine whether the cleaning medium 404 is damaged and/or broken during cleaning; and a feed roller empty sensor 434 may be disposed adjacent feed roller 402 to determine whether the feed roller 402 is empty or about to be empty. The cleaning medium sensor 432 and/or feed roller empty sensor 434 also may be coupled to the controller 430.

In the exemplary embodiment of FIG. 4, the feed roller 402 may initially hold a spool or roll of cleaning medium 404. In some embodiments, the feed roller 402 may be formed from Teflon® and/or aluminum and have a diameter of about 3 to 4 inches, although other materials and/or sizes may be used. Cleaning medium 404 may be threaded from the feed roller 402 over the tension roller 408, adjustment roller 412, and idle roller 424 to be wrapped onto take up roller 426. In some embodiments, fewer or more rollers may be employed. For example, in one or more embodiments, the tension roller 408 and/or the idle roller 424 may be eliminated.

The cleaning medium 404 may be any material suitable for use in wiping the nozzle plate 414 or other surface of a print head 416, such as a particle free medium, and may contain a cleaning fluid (e.g., water or solvent) suitable for cleaning inkjet print heads. For example, the cleaning medium 404 may be 100% non-woven polyester, such as SatWipes C3 Wiper manufactured by Contec, Inc. of Spartanburg, S.C. In some embodiments a solvent (e.g., PGMEA (propylene glycol methyl ether acetate), acetone, etc.) or other cleaning fluid may be sprayed (e.g., via a spray nozzle) or otherwise deposited onto the cleaning medium 404. In the same or other embodiments, the cleaning fluid may be deposited directly onto the inkjet print head 416.

In some embodiments, the tension roller 408 may be formed from Teflon® and/or aluminum and have a diameter of about one inch, although other materials and/or sizes may be used. The tension of the cleaning medium 404 may be measured via the tension sensor 410. This information may be relayed to controller 430. The relative position and angle of tension roller 408 may be adjusted based on the determined tension (e.g., manually or automatically, such as under direction of the controller 430) to achieve a desired tension of the cleaning medium 404. In at least one embodiment, tension of the cleaning medium 404 may be approximately 50 to 1000 grams, although any appropriate tension may be used. In the same or alternative embodiments, tension may be determined in part by measuring motor torque of feed motor 406 and/or take-up motor 428.

The adjustment roller 412 may be adjustable so as to change the angle of approach of the cleaning medium 104 with respect to the nozzle plate 414. It may be desirable to achieve as small an approach angle as possible, preferably about 15 degrees or less, so as to maintain a substantially parallel planar relationship between the nozzle plate 414 and the cleaning medium 404 at the initial point of contact. The approach angle may be adjusted such that the maximum wiping occurs without shaving the nozzle plate 414 or causing misalignment of print head 416. Shaving may result from the cleaning medium 404 contacting a leading edge of the nozzle plate 414 causing particle generation.

In at least one embodiment, the adjustment roller 412 may be formed from Teflon® and/or aluminum and have a diameter of about one inch. Other adjustment roller materials and/or sizes may be used.

In some embodiments, the position of the adjustment roller 412 may be adjustable (e.g., by adjustment of a supporting block (not shown)) to compensate for tension variations resulting from changes in the geometry of the cleaning medium 404 path over the tension roller 408 as the roll of cleaning medium 404 is transferred from the feed roller 402 to the take up roller 426. In the same or alternative embodiments, the position of the adjustment roller 412 may also be adjustable to compensate for variations in the thickness of cleaning medium 404 or any offset in the position of inkjet print head 416. Additionally, the position of the adjustment roller 412 may be adjustable to improve clearance so that inkjet print head 416 may be moved to a parking station (not shown) when the print head is not in use. In an exemplary embodiment, with the adjustment roller 412 set to about a two degree approach angle and the bladder 418 deflated, a clearance of approximately 2.3 mm, less cleaning medium 404 thickness, may be provided for the inkjet print head 416 to pass en route to the parking station (not shown).

During the cleaning operation, inkjet print head 416 may be located at the cleaning station 416A. The cleaning station 416A may be capable of housing a single inkjet print head 416, a row of inkjet print heads, or any other suitable amount and/or arrangement of inkjet print heads. In an exemplary embodiment, cleaning station 416A may be a structure adapted to hold an inkjet print head or heads 416 in a particular location. Inkjet print heads 416 may be mounted to a rail (not shown) and may be moved into position at the cleaning station 416A. In other embodiments, the cleaning station 416A may be a space (e.g., gap, door, window, etc.) in a wall surrounding part or all of inkjet print head cleaning system 400.

In one or more embodiments, the inflatable bladder 418 may be positioned such that it is proximate to the nozzle plate 414 in an inflated state. As shown, the bladder 418, in an inflated state, may occupy a length of the space between the adjustment roller 412 and the idle roller 424 in order to provide a contacting surface in the longitudinal dimension (the dimension in which the cleaning medium 404 is conveyed past the nozzle plate 414) for supporting the cleaning medium. The bladder 418 may be composed of an elastic material, such as Teflon® or any other suitable polymeric, fibrous material or fabric having suitable properties, such as elasticity and low coefficient of friction. The bladder 418 may be generally rectangular in shape as shown, but may also comprise a variety of different webbings and thus may form different shapes in an inflated state. For example, in some embodiments, it may be desired to exert greater force on the cleaning medium 404 in a position directly below the print head 416, and the bladder may be formed to have an extending point or arch in this location.

The bladder 418 may be coupled via a conduit 422 to a source of pressurized gas such as air or any another suitable gas (e.g., nitrogen) or combination of gases. A pressure regulator 420 may regulate the gas flow rate and pressure through the conduit 422, and may thus control the rate at which the bladder inflates/deflates and also the gas pressure within the bladder 418 when it is in a fully or semi-inflated state. Since the physical characteristics of the fully inflated bladder, such as its volume, elasticity and shape are affected by the pressure to which it is inflated, the gas pressure may be set optimize these characteristics for providing a substantially flat, uniform and firm contacting surface helpful for maintaining a to maintain a substantially parallel planar relationship between the cleaning medium 404 and the nozzle plate 414. It is envisioned that gas pressures in the range of 0.5 to 10 psi (pounds per square inch) may be suitable in some applications, but other pressures may be used.

Idle roller 424 may be used to guide cleaning medium 404 and adjust the departure angle of the cleaning medium 404 with respect to the nozzle plate 414 (in a manner similar to how adjustment roller 412 adjusts approach angle). Idle roller 424 may also be used to adjust a tension in cleaning medium 404, and may be of a similar size and material as the adjustment roller 412 (although other sizes and/or materials may be used). The idle roller 424 may be stationary and adjustable in position.

As stated, cleaning medium 404 may be wrapped onto take up roller 426 after use in the inkjet print head cleaning system 400. Take up roller 426 may be driven by take up motor 428. Take up motor 428 may be a belt driven motor, although any other suitable motor may be used. Take up roller 426 may be of a similar size and material as feed roller 402, although other sizes and/or materials may be used.

The controller 430 may be operably connected to the feed motor 406, take up motor 428, tension sensor 410, or any other part of the cleaning system 400. Additionally, the controller 430 may be operably connected to the pressure regulator 420. Controller 430 may be any suitable computer or computer system, including, but not limited to, a mainframe computer, a minicomputer, a network computer, a personal computer, and/or any suitable processing device, component, or system. Likewise, the controller 430 may comprise a dedicated hardware circuit or any suitable contribution of hardware and software.

In at least one embodiment, the controller 430 may monitor feed roll size, torque, and/or rotational speed, take up roll size, torque, and/or rotational speed, cleaning medium tension, cleaning medium distance traveled, and/or cleaning media speed. Controller 430 may utilize this information to control the various attributes and components of the system 400 so as to ensure a functional cleaning process. For example, in an exemplary embodiment, controller 430 may monitor tension, speed, and the distance traveled of the cleaning medium 404 as well as the amount of cleaning medium still rolled onto feed roll 402 and/or take up roll 426. As tension is measured by tension sensor 410, this information may be used by the controller 430 to adjust the speed of the feed motor 406 or take up motor 428 (e.g., to keep an approximately constant tension on cleaning medium 404). As the speed of the cleaning medium 404 is monitored, the speeds of both the take up motor 406 and feed motor 428 may be adjusted (e.g. to keep the cleaning medium 404 traveling at an approximately constant speed). Similarly, information about the cleaning medium 404 distance traveled and the size of the cleaning medium 404 rolls on feed roll 402 and/or take up roll 426 may be used to determine and/or adjust the take up motor 406 speed and feed motor 428 speed (e.g., to affect cleaning medium speed and/or tension).

In another embodiment, the speed and distance traveled of the cleaning medium 404, the feed motor 406 torque, and the size of the cleaning medium 404 rolls on feed roll 402 and/or take up roll 426 may be known, measured, and/or adjustable by controller 430. Cleaning medium 404 speed may be used by the controller 430 to adjust take up motor 428 speed. Feed motor 406 torque may be used by the controller 430 to adjust feed motor 406 torque. Similarly, the diameter of the cleaning medium 404 on either or both of the feed roller 402 and the take-up roller 426 may be used in conjunction with a measured motor torque on either or both of the feed motor 406 and the take-up motor 428 by the controller 430 to control the cleaning medium 404 tension. The motor torque of the feed motor 406 and/or the take-up motor 428 may be inversely proportional to the measured cleaning medium 404 diameter when cleaning medium 404 tension is kept constant.

In one or more embodiments, the controller 430 may monitor and control the pressure regulator 420 to inflate/deflate and/or set the pressure of the gas within the bladder 418 to an appropriate level. For example, the controller 430 may operate the pressure regulator 420 to set and maintain a gas pressure level within the bladder 418 of between 0.5 and 10 psi.

Cleaning medium breakage sensor 432 is adapted to determine a defect in the cleaning medium 404. In a particular embodiment, breakage sensor 432 may be disposed between the tension roller 408 and adjustment roller 412 although other locations may be used. In some embodiments, breakage sensor 432 may be an optical sensor that detects the presence or absence of the cleaning medium 404 (e.g., via reflection or a through beam) or may be any other suitable sensor or device. For example, the breakage sensor 432 may include a light beam source 432a and a detector 432b that only detects a light beam from the light beam source 432a when the clean medium 404 is not present or improperly positioned between the light beam source 432a and detector 432b. Absence of the cleaning medium 404, or a change in the transmission characteristics through the cleaning medium 404, may indicate a defect (e.g., breakage of the cleaning medium 404, improper cleaning medium type, etc.)

Feed roller empty sensor 434 may be disposed adjacent feed roller 402 and be adapted to monitor the roll size of cleaning medium 404 on the feed roller 402. For example, the feed roller empty sensor 434 may include a light source adapted to transmit a light beam toward a detector (not shown) that detects the light beam only if the diameter of cleaning medium 404 on the feed roller 402 is below a predetermined size (e.g., indicating the feed roller 402 is or is about to be empty). Other feed roller empty sensors may be used including, for example, a sensor that measures the weight of the feed roller 402 to determine the amount of cleaning medium 404 on the feed roller 402 or a reflected ultrasound or laser sensor. As cleaning medium 404 pays out during a cleaning process, the roll size (diameter) may be monitored to prevent running out of cleaning medium 404 during the cleaning process. In one embodiment, a feed roller empty sensor 434 may be mounted perpendicular to the feed roller 402.

If a designated cleaning medium 404 roll-change point is desired, a discrete-output sensor may be used, such as the light source/detector embodiment described above. In another embodiment, the feed roller empty sensor 434 may be adapted to measure how much cleaning medium 404 has been payed out by the feed roller 402 and configured and/or programmed with a specific distance which corresponds to a low supply condition, at which point the output of the feed roller empty sensor 434 changes state. If a continuous inventory is desired, an analog-output sensor may be used. Feed roller empty sensor 434 may be taught a distance which corresponds to the full roll, and a distance to the empty roll. As the cleaning medium 404 pays out, the sensor may send an analog signal that is scaled to represent the shrinking size of the roll. Any other suitable sensor may be used.

Feed roller empty sensor 434 may also be used to measure a diameter of the cleaning medium 404 mounted on feed roller 402. The diameter of the cleaning medium 404 may be used by the controller 430 to control tension of the cleaning medium 404.

FIG. 5 is an enlarged side view of a portion of FIG. 4 showing an exemplary arrangement of the contacting surface 502 of the inflatable bladder 518 with respect to the cleaning medium 504 for cleaning a print head 510 according to the present invention. In the embodiment of FIG. 5, the bladder 518 may be inflated to an ‘operating’ volume and into a position in which it presents a large contacting surface 502 along which the cleaning medium 504 may be conveyed. The volume of the bladder 518 may be limited such that when inflated to the operating volume it does not come into contact with an inkjet print head 510 located at a cleaning station location 510A.

In operation, the bladder 518 may be operable to apply a level of pressure against the cleaning medium 104 and and to move the cleaning medium 504 in proximity of cleaning station location 510A, which may house the inkjet print head 510, while supporting the cleaning medium 504 securely such that slippage, abrupt movements and/or breakage is unlikely to occur.

An example of a commercially available print head suitable for use with the present invention is the model SE-128, 128-Channel Jetting Assembly manufactured by Dimatix, Inc. of Lebanon, N.H. This particular jetting assembly includes two electrically independent piezoelectric slices, each with sixty-four addressable channels, which are combined to provide a total of 128 jets. The print head includes a number of nozzles which are arranged in a single line, at approximately 0.020″ distance between nozzles. Other print heads with differently sized nozzles may also be used.

When inflated to the operating volume, the bladder 518 may be positioned in proximity of the nozzle plate 514 of inkjet print head 510, which is located at the cleaning station 510A. In some embodiments, the pressure exerted against the cleaning medium 504 by the bladder 518 or the “pressure load” is set by the prevailing pressure within the bladder 518 by the pressure regulator 420 (shown in FIG. 4). Other pressure load adjustment mechanisms may be used, such as mechanical means that may be used to check or alter the force that the contacting surface 502 of the bladder 518 may exert on the cleaning medium 504, and in turn, on the nozzle plate 514 of the print head 510. The pressure load may adjusted to compensate for changes in cleaning medium 504 tension and approach angle. In the same or alternative embodiments, the pressure load may be set to compensate for variations in the thicknesses of the bladder material and/or the cleaning medium 504.

In the depicted embodiment, when the bladder 518 is inflated its top surface, the contacting surface 502, is elongated in the longitudinal dimension and is approximately parallel along this length to the surface of the nozzle plate 514. In one or more embodiments, the inflated bladder 518 exerts pressure on the cleaning medium 504 such that the cleaning medium is pressed, without undue force, against the contour of the contacting surface 502 of the bladder for a substantial longitudinal length. Along the length in which it is in contact with the inflated bladder 518, the cleaning medium 504 may be aligned substantially parallel to the nozzle plate 514 in conformance with the contacting surface of the inflated bladder 518. This alignment of the cleaning medium 504 may be advantageous for providing a large surface area and a uniform contacting force for cleaning the nozzle plate 514. As noted, in one or more embodiments, the bladder 518 surface may have a different shape and/or may be inflated at greater pressure so as to exert a greater force on the cleaning medium toward the nozzle plate 514 (e.g., to remove more firmly attached contaminants). In such cases, the contacting surface and cleaning medium may vary from a parallel relation to the nozzle plate 514 surface. For example, in one or more embodiments, the surface of the bladder 518 may be curved so as to prevent contact between the bladder 518 and corners of the inkjet print head 510 or any other surface features which may potentially damage the bladder 518 or prevent suitable contact between the cleaning medium 504 and the nozzle plate 514 through frictional contact.

As stated, the bladder 518 position and volume may be limited to prevent unwanted or excessive contact with inkjet print head 510. In one or more embodiments, the operating volume of the bladder 518 may be set so that the contacting surface 502 reaches approximately 0.1 mm past the point of contact with nozzle plate 514. This ‘up limit’ 508 may be used to set an initial position for the inflated bladder 518 and setting of the pressure load. Up limit 508 may be set at any appropriate point conducive to the bladder 518 volume, inkjet print head 510 position, or any other factor which may affect the point of contact between the contacting surface 502 of the bladder and the nozzle plate 514. The bladder 518 may be further limited so as to prevent contact with other parts of system 400.

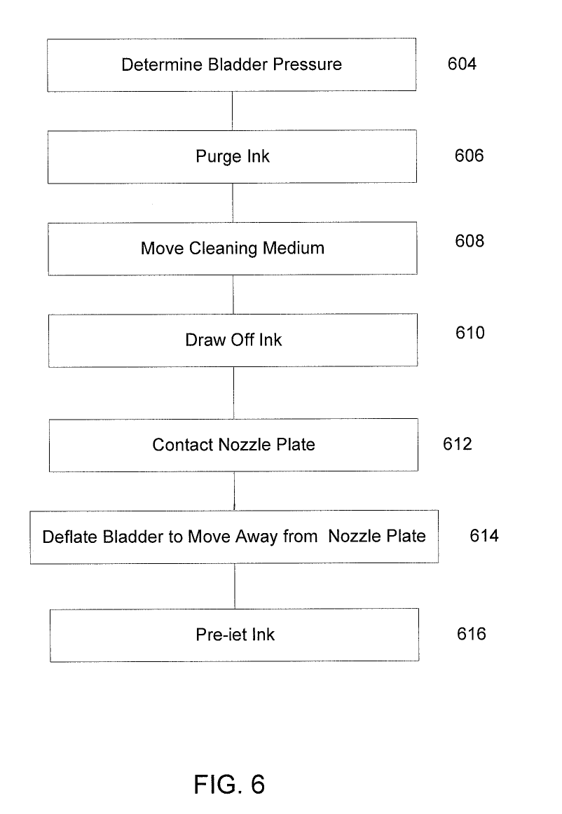

Turning to FIG. 6, a flowchart depicting an alternative exemplary method 600 of inkjet print head cleaning according to the present invention is illustrated. In Step 604, an appropriate pressure at which to inflate the bladder 518 against the cleaning medium 504 is determined. In at least one embodiment, the pressure should be sufficient so as to cause the cleaning medium 504 to contact and wipe the nozzle plate 514 of the inkjet print head 510 without causing damage to or misalignment of the inkjet print head 510. The pressure applied by the bladder 518 may avoid shaving, or particle generation resulting from contact of cleaning media 504 against the leading edge of the nozzle plate 514. The pressure applied by the bladder 518 may be determined experimentally or may be set at any pre-determined setting. In some embodiments, the pressure applied may be between about 0.5 and 10 psi. Other pressures may be used.

In step 606, ink remaining in the inkjet print head 510 may be purged. To purge ink from the print head 510, the ink remaining inside the inkjet print head 510 may be forced out via any suitable method. This may include, for example, jetting ink or air through the inkjet print head 510. In one or more embodiments, ink or air may be jetted through the inkjet print head 510 using a pulse of duration of about 0.5 seconds, although any other pulse widths may be used. In an exemplary embodiment, inkjet print head 510 may purge between approximately three and six cubic centimeters of ink per cycle. Inkjet print head 510 may be purged onto cleaning medium 504 at cleaning station 510A or at a parking station (not shown).

In step 608, cleaning medium 504 may be moved. Moving cleaning medium 504 may include rotating feed roller 402 (shown in FIG. 4) so as to dispense cleaning medium 504 from the feed roller 402 and rotating take up roller 426 (shown in FIG. 4) so as to re-spool used cleaning medium 504 onto the take up roller 426. Any appropriate cleaning medium 504 speed may be employed. In an exemplary embodiment, cleaning medium 504 may be moved at a speed of approximately 10-150 mm/s.

During step 608, the speed of the cleaning medium 504 also may be adjusted. For example, adjustment of a cleaning medium 504 speed may be made by first determining a current cleaning medium speed. The current cleaning medium speed may be determined by measuring a tension of the cleaning medium, a distance traveled by the cleaning medium 504, comparing a first feed roll size to a second feed roll size, comparing a first take up roll size to a second take up roll size, any combination thereof, or the like. Any other suitable method may be used to determine speed of the cleaning medium 504. The current cleaning medium speed may then be adjusted, for example, by adjusting a feed roller rotational speed, a take up roller rotational speed, a cleaning medium tension, or any combination thereof. Any other suitable method may be used to adjust cleaning medium 504 speed. A feed roller 402 rotational speed may be adjusted by adjusting the motor speed of feed motor 406. Similarly, a take up roller 426 rotational speed may be adjusted by adjusting the motor speed of take up motor 428.

In step 610, bladder 518 may be inflated to press against cleaning medium 504 proximate to nozzle plate 514. This may cause any liquid ink remaining on nozzle plate 514 to be wicked or drawn off the nozzle plate 514 onto cleaning medium 504. For example, bladder 518 may be inflated via pressure regulator 420 or any suitable method and/or device. The bladder 518 may be inflated incrementally (e.g., so as to continually adjust the bladder 518 volume and position, such as based on feedback from controller 430); or the bladder 518 may inflated rapidly in a single step to a predetermined volume/position.

In step 612, the bladder 518 may be inflated further to exert pressure on the cleaning medium 504 and move it so as to cause cleaning medium 504 to contact the surface of nozzle plate 514 and wipe away any remaining ink. In at least one embodiment, pressure exerted by cleaning medium 504 on the nozzle plate 514 may be sufficient to scrape away any ink from the nozzle plate 514, but insufficient to cause damage to and/or mis-alignment of the inkjet print head 510.

In step 614, bladder 518 may be deflated via the pressure regulator 420, causing cleaning medium 504 to move away from nozzle plate 514. The bladder 518 may be deflated incrementally based on feedback from controller 430, or the bladder 518 may be deflated rapidly in a single step to a predetermined position.

In step 616, ink may be pre-jetted from inkjet print head 510. Pre-jetting ink may cause ink to be jetted from the inkjet print head 510 after cleaning and before returning to a print process. Ink may be pre-jetted onto cleaning medium 504 at cleaning station 510A or may be pre-jetted at a parking station (not shown).

The foregoing description discloses only exemplary embodiments of the invention; modifications of the above disclosed methods and apparatus which fall within the scope of the invention will be readily apparent to those of ordinary skill in the art. For instance, although the above example methods are described with reference to only one adjustment roller 112 and one idle roller 124 as described above with reference to FIGS. 1 and 4, one of ordinary skill in the art would understand that these methods may be applied to any suitable number of adjustment and/or idle rollers in the inkjet print head cleaning systems 100, 400 (e.g., 2, 3, 4, etc.). In some embodiments, the inkjet print head cleaning systems 100, 400 of the present invention may be mounted on and/or used with an inkjet printing system such as disclosed in U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” which is hereby incorporated herein by reference in its entirety for all purposes. Further, the present invention may also be applied to spacer formation, polarizer coating, and nanoparticle circuit forming.

Accordingly, while the present invention has been disclosed in connection with specific embodiments thereof, it should be understood that other embodiments may fall within the spirit and scope of the invention, as defined by the following claims.

What is claimed is:

1. A method of cleaning an inkjet print head comprising:
positioning the inkjet print head proximate an inkjet print head cleaning apparatus;
positioning a cleaning medium of the inkjet print head cleaning apparatus proximate the inkjet print head;
contacting the cleaning medium with an inflatable bladder so as to exert a pressure on the cleaning medium; and
moving the cleaning medium relative to the inkjet print head so as to clean the inkjet print head.

2. The method of claim 1 further comprising:
purging ink from the inkjet print head prior to the pressure roller contacting the cleaning medium; and
pre-jetting ink from the inkjet print head after moving the cleaning medium.

3. The method of claim 2 wherein purging ink from the inkjet print head comprises purging ink at a parking station.

4. The method of claim 2 wherein purging ink from the inkjet print head comprises purging ink onto the cleaning medium.

5. The method of claim 1 wherein contacting the cleaning medium with an inflatable bladder comprises exerting pressure on the cleaning medium sufficient to wipe a nozzle plate of the inkjet print head but insufficient to cause damage to or misalignment of the inkjet print head.

6. The method of claim 1 wherein moving a cleaning medium comprises:
moving the cleaning medium in proximity of a nozzle plate of an inkjet print head;
contacting the nozzle plate with the cleaning medium; and
moving the cleaning medium away from the nozzle plate.

7. The method of claim 1 further comprising:
rotating a feed roller adapted to dispense the cleaning medium; and
rotating a take up roller adapted to collect used cleaning medium.

8. The method of claim 1 further comprising:
determining for the cleaning medium at least one of a tension, a speed, a distance traveled, a feed roll size, and a take-up roll size; and
adjusting a cleaning medium speed based on the at least one of the determined tension, speed, distance traveled, feed roll size, and take-up roll size.

9. The method of claim 8 wherein adjusting a cleaning medium speed comprises adjusting at least one of a speed of a feed roller motor and a take up roller motor.

10. The method of claim 1 wherein contacting the cleaning medium with the inflatable bladder comprises inflating the bladder to exert sufficient force on the cleaning medium to cause the cleaning medium to contact a nozzle plate of the inkjet print head.

11. The method of claim 1 further comprising depositing a cleaning fluid onto the cleaning medium.

12. The method of claim 1 further comprising controlling a web tension during cleaning.

13. The method of claim 12 wherein controlling a web tension comprises checking a motor torque and a cleaning medium diameter.

14. An apparatus comprising:
a cleaning station adapted to provide a location to support an inkjet print head during cleaning; and
an inflatable bladder adapted to move a cleaning medium proximate to the cleaning station.

15. The apparatus of claim 14 further comprising:
a pressure regulator coupled to the inflatable bladder and adapted control a gas pressure within the bladder.

16. The apparatus of claim 15, further comprising:
a controller coupled to the pressure regulator and adapted to monitor the gas pressure within the bladder and to control the pressure regulator to set the gas pressure.

17. A system comprising:
an inkjet head cleaning module having;
a feed roller adapted to supply a cleaning medium;
a take up roller adapted to receive the cleaning medium from the feed roller;
a tension roller adapted to tension the cleaning medium as it is supplied from the feed roller to the take up roller; and
an inflatable bladder adapted to exert a pressure on the cleaning medium supplied from the feed roller to the take up roller toward an inkjet print head so as to clean the inkjet print head.

18. The system of claim 17 further comprising:
a controller adapted to determine for the cleaning medium at least one of a tension, speed, distance traveled, feed roll size, and take up roll size; and
adjust a cleaning medium speed according to the at least one of the determined tension, speed, distance, feed roll size, and take up roll size.

19. The system of claim 18 further comprising:
at least one adjustment roller adapted to adjust an approach angle of the cleaning medium with respect to the inkjet print head.

20. The system of claim 19 wherein the approach angle is less than about 15 degrees or less.

21. The system of claim 19 further comprising:
at least one idle roller adapted to adjust a departure angle of the cleaning medium with respect to the inkjet print head.

22. The system of claim 21 wherein the departure angle is less than about 15 or less degrees.

23. The system of claim 17 further comprising:
a sensor adapted to detect a defect in the cleaning medium.

24. The system of claim 23 wherein the sensor is adapted to detect a break in the cleaning medium.

25. The system of claim 24 wherein the sensor comprises:
a light emitter adapted to transmit a light beam toward the cleaning medium;
a detector adapted to receive the light beam from the light emitter; and
circuitry adapted to determine whether the transmitted light beam is received by the detector.

26. The system of claim 17 further comprising:
a sensor adapted to detect an amount of cleaning medium spooled on the feed roller.

27. The system of claim 26 wherein the sensor comprises:
a light source adapted to transmit a light beam toward the feed roller;
a detector adapted to receive the light beam from the light source; and
circuitry adapted to determine whether the transmitted light beam is received by the detector.

28. The system of claim 26 wherein the sensor is a reflected ultrasound sensor.

29. The system of claim 26 wherein the sensor is a scale adapted to convert a weight of the cleaning medium on the feed roller to an amount of cleaning medium.

30. The system of claim 17 further comprising a tension sensor adapted to detect a tension of the cleaning medium as the cleaning medium is supplied from the feed roller to the take up roller.
